(19) United States
(12) Patent Application Publication
(10) Pub. No.: US 2026/0023722 A1
(43) Pub. Date: Jan. 22, 2026

(54) Overcoming Prompt Token Limitations Through Semantic Driven Dynamic Schema Integration For Enhanced Query Generation

(71) Applicant: Ordr Inc., Santa Clara, CA (US)

(72) Inventors: Sakthi Dasan Sekar, Chennai (IN); Gnanaprakasam Pandian, Cupertino, CA (US); Sheausong Yang, Saratoga, CA (US)

(73) Assignee: Ordr Inc., Santa Clara, CA (US)

(21) Appl. No.: 18/774,816

(22) Filed: Jul. 16, 2024

(51) Int. Cl. G06F 16/21; G06F 16/242

(52) U.S. Cl. CPC G06F 16/212; G06F 16/243

(57) ABSTRACT

Techniques for integrating one or more dataset schemas with a natural language prompt to generate a query for obtaining results to the natural language prompt are disclosed. In some embodiments, a method comprises the following: receiving user input comprising a natural language prompt; generating an instruction for a Large Language Model (LLM) to generate a query, wherein the instruction specifies the natural language prompt and a first subset of dataset schemas; submitting the instruction to the LLM, wherein the LLM generates the query based on the instruction; receiving the query from the LLM, wherein the query is based on and directed to the first subset of dataset schemas; executing the query on the data repository to generate a set of one or more results based on the first subset of dataset schemas; and storing the set of one or more results in response to the natural language prompt.

### TECHNICAL FIELD

The present disclosure relates to a system that generates queries based on natural language prompts. In particular, the present disclosure relates to a system that generates queries by integrating dataset schemas with natural language prompts.

### BACKGROUND

A natural language is any language that occurs naturally in a human community, such as the native speech of a people, by a process of use, repetition, and change without conscious planning or premeditation. A natural language prompt is natural language text that describes a task to be performed by a computer system. Natural language prompts may be input into artificial intelligence (AI) models to generate responses.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for integrating dataset schemas with natural language prompts for enhanced query generation accordance with one or more embodiments;

FIG. 3 illustrates an example set of operations for generating an instruction for an LLM to generate a query in accordance with one or more embodiments;

FIG. 4 illustrates another example set of operations for generating an instruction for an LLM to generate a query in accordance with one or more embodiments;

FIG. 5 illustrates yet another example set of operations for generating an instruction for an LLM to generate a query in accordance with one or more embodiments;

FIG. 6 a block diagram that illustrates a computer system in accordance with one or more embodiments.

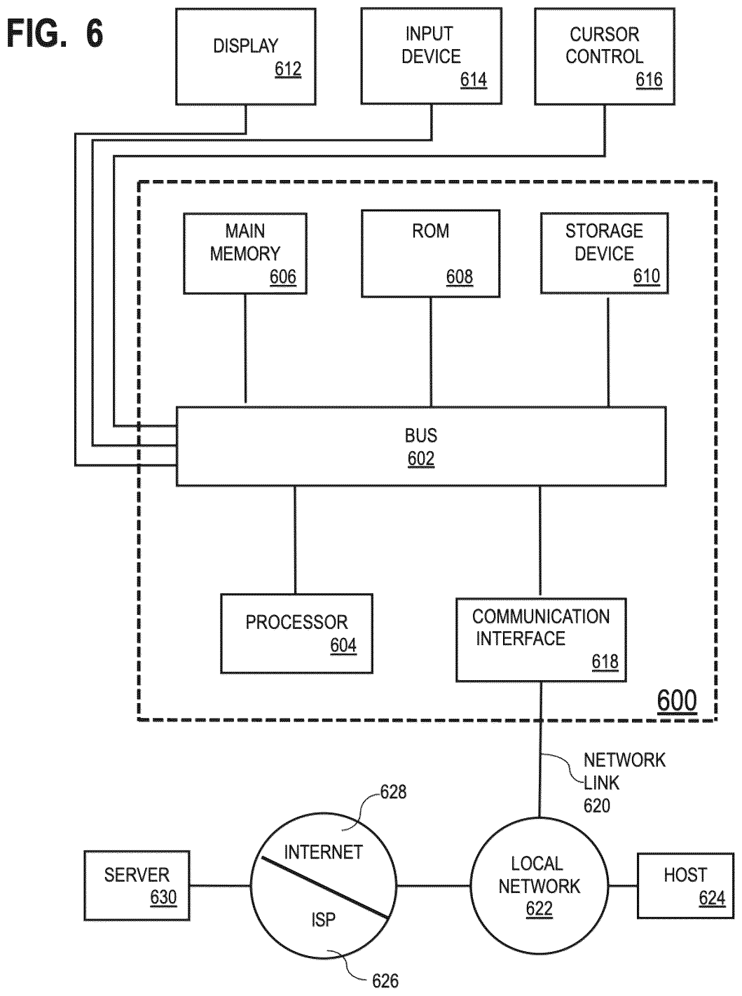

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SYSTEM ARCHITECTURE
3. INTEGRATING DATASET SCHEMAS WITH NATURAL LANGUAGE PROMPTS FOR ENHANCED QUERY GENERATION
4. EXAMPLE EMBODIMENTS
5. COMPUTER NETWORKS AND CLOUD NETWORKS
6. HARDWARE OVERVIEW
7. MISCELLANEOUS; EXTENSIONS

### 1. GENERAL OVERVIEW

One or more embodiments include a system that integrates one or more dataset schemas with a natural language prompt received from a user to generate a query for obtaining results to the natural language prompt. The system receives user input that includes the natural language prompt and generates an instruction for a Large Language Model (LLM) to generate the query. The system generates the instruction by comparing a first feature vector of the natural language prompt to each of a set of feature vectors of a set of dataset schemas of a data repository to identify a subset of the set of feature vectors that satisfy a first similarity criteria. The system then generates an instruction to the LLM to generate the query based on the natural language prompt and the subset of dataset schemas that correspond to the identified subset of feature vectors. The system submits the instruction to the LLM, and the LLM generates the query based on the instruction. The system then executes the query on the data repository to generate a set of results and stores the set of results in response to the natural language prompt. In an embodiment, the system presents the set of one or more results in response to the natural language prompt.

The system may use different techniques for selecting the dataset schemas to integrate with the natural language prompt in the instruction to generate the query. In some embodiments, the system selects dataset schemas that satisfy the first similarity schema based on a comparison of the corresponding feature vectors of the dataset schemas with the first feature vector of the natural language prompt. In some embodiments, even if a dataset schema does not satisfy the first similarity criteria, the system may still select that dataset schema based on determining that the dataset schema is semantically related to a dataset schema that satisfied the first similarity criteria. In some embodiments, in addition to requiring that the dataset schema is semantically related to a dataset schema that satisfied the first similarity criteria to include the dataset schema in the instruction to the LLM when the dataset schema does not satisfy the first similarity criteria, the system further requires that the dataset schema satisfy a second similarity criteria that is different from the first similarity criteria.

In an embodiment, the comparison of the first feature vector of the natural language prompt with the feature vectors of the dataset schemas to determine if the first similarity criteria is satisfied includes calculating corresponding similarity metrics between the first feature vector and the individual feature vectors of the dataset schemas and determining if the similarity metrics satisfy a first threshold value. In one or more embodiments, the comparison of the first feature vector of the natural language prompt with the feature vectors of the dataset schemas to determine if the second similarity criteria is satisfied includes calculating corresponding similarity metrics between the first feature vector and the individual feature vectors of the dataset schemas and determining if the similarity metrics satisfy a second threshold value that is different from the first threshold value. In some embodiments, the similarity metrics include corresponding cosine similarities between the first feature vector and the respective feature vectors of the dataset schemas. In one or more embodiments, the first threshold value is satisfied for a feature vector of a dataset schema if the corresponding cosine similarity is equal to or above the first threshold value, and the second threshold value is satisfied for the feature vector of the dataset schema if the corresponding cosine similarity is equal to or above the second threshold value. In some alternative embodiments, the similarity metrics include corresponding cosine distances between the first feature vector and the respective feature vectors of the dataset schemas. Here, the first threshold value is satisfied for a feature vector of a dataset schema if the corresponding cosine distance is equal to or below the first threshold value, and the second threshold value is satisfied for the feature vector of the dataset schema if the corresponding cosine distance is equal to or below the second threshold value. Other types of similarity metrics and other ways of determining if the similarity metrics satisfy the first threshold value and the second threshold value are also within the scope of the present disclosure.

In one or more embodiments, each dataset schema in the set of dataset schemas corresponds to a different table in the database, and each dataset schema defines data that is stored in the table corresponding to the dataset schema. In some embodiments, the instruction to the LLM to generate the query specifies rules for restricting what types of database operations may be used in executing the query. For example, the instruction to the LLM may specify that the database operations to be performed in the execution of the query may be restricted to READ operations, or no DELETE operations or any operations that change or rename objects in a table may be performed in the execution of the query. Other restrictions are also within the scope of the present disclosure.

One or more embodiments described in this Specification and/or recited in the claims may not be included in this General Overview section.

### 2. SYSTEM ARCHITECTURE

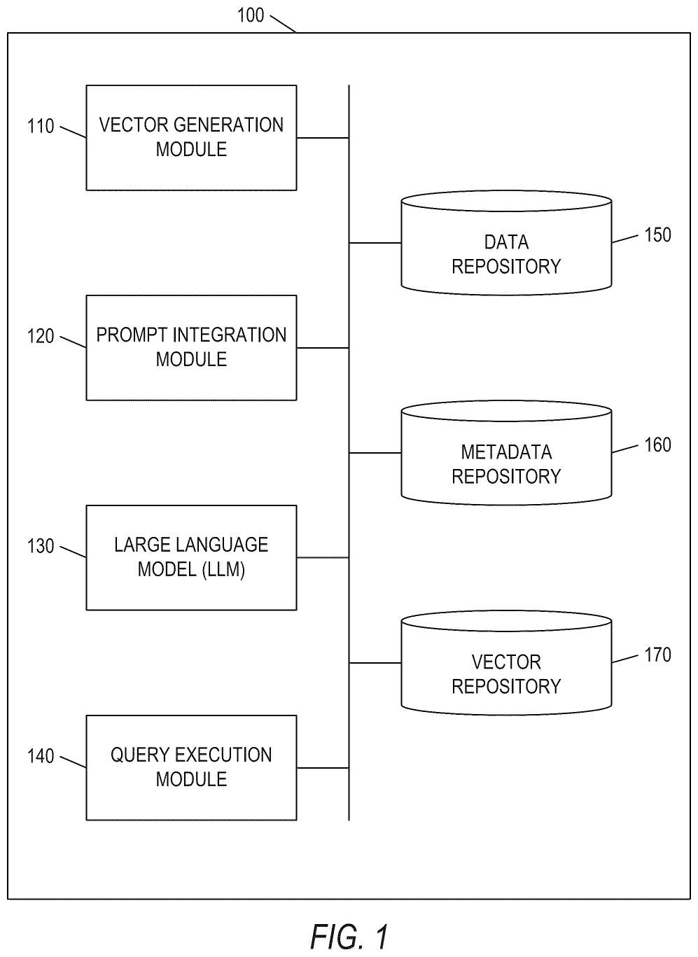

FIG. 1 illustrates a system 100 in accordance with one or more embodiments. As illustrated in FIG. 1, system 100 includes a vector generation module 110, a prompt integration module 120, a large language model (LLM) 130, a query execution module 140, a data repository 150, a metadata repository 160, and a vector repository 170. In one or more embodiments, the system 100 may include more or fewer components than the components illustrated in FIG. 1. The components illustrated in FIG. 1 may be local to or remote from each other. The components illustrated in FIG. 1 may be communicatively coupled to each other via a direct connection or via a network. The components illustrated in FIG. 1 may be implemented in software and/or hardware. Each component may be distributed over multiple applications and/or machines. Multiple components may be combined into one application and/or machine. Operations described with respect to one component may instead be performed by another component.

In an embodiment, the components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the data repository 150, the metadata repository 160, and the vector repository 170 may each be any type of storage unit and/or device (e.g., a file system, database, collection of tables, or any other storage mechanism) for storing data. Furthermore, the data repository 150, the metadata repository 160, and the vector repository 170 may each include multiple different storage units and/or devices. The multiple different storage units and/or devices may or may not be of the same type or located at the same physical site.

The system 100 is configured to receive a user input comprising a natural language prompt and generate a set of one or more results in response to the user input. In one or more embodiments, the user input is received from a computing device connected to the system 100 such as via a computer network. In one example, a user of the computing device provides the user input as audio input by speaking into a microphone of the computing device. In another example, the user of the computing device provides the user input as text by typing the text using a keyboard of the computing device. Other types of user input and other devices for collecting the user input are also within the scope of the present disclosure.

In one or more embodiments, the natural language prompt includes natural language text that describes a task to be performed by a computer system. For example, the task may include executing a query on the data repository 150. In some embodiments, the data repository 150 stores data managed by a Cyber Asset Attack Surface Management (CAASM) system. A CAASM system helps organizations identify and manage potential vulnerabilities in their assets, such as computing devices, hardware, cloud assets, and applications. The CAASM system may consolidate and normalize asset data. The asset data may include a corresponding identifier for each asset being managed, as well as attributes (e.g., technical specifications) of the asset and other data (e.g., usage data) related to the asset. In an embodiment, the asset data is stored in the data repository 150. In other embodiments, the data repository 150 stores other types of data other than the asset data discussed above. In some embodiments, the data repository 150 stores data in tables. For example, the data repository 150 may comprise a database that stores each of a plurality of datasets in a corresponding table of the data repository 150 (e.g., a first dataset is stored in a first table, a second dataset is stored in a second table, a third dataset is stored in a third table, and so on and so forth).

In some embodiments, the metadata repository 160 stores a corresponding dataset schema for each dataset stored in the data repository 150. Each dataset schema defines the data that is stored in the corresponding data structure in the data repository 150. In one example in which each dataset schema corresponds to a different table in the data repository 150, each dataset schema defines the data that is stored in the table that corresponds to the dataset schema. In an embodiment, the dataset schema specifies a name and data type for each field in the corresponding table. The dataset schema may represent the structure of the corresponding data structure (e.g., the structure of the corresponding table) that defines the objects in the data structure and impose integrity constraints on the corresponding data structure. In some embodiments, the dataset schema is defined in a text-based database language. However, other forms of the dataset schema are also within the scope of the present disclosure.

In some embodiments, the vector generation module 110 is configured to execute an embedding operation to generate a feature vector for the natural language prompt included in the user input and to generate a corresponding feature vector for each dataset schema in a set of dataset schemas stored in the metadata repository 160. In an embodiment, the feature vector is a numerical representation of a set of features of the corresponding data object (natural language prompt or dataset schema). An attribute or characteristic of the data object may be represented by each member of the feature vector. In one or more embodiments, the vector generation module 110 generates the feature vectors using a machine learning algorithm that trains a model to turn data of the corresponding data object into a numerical vector. The vector generation module 110 may use a deep convolutional neural network to train the model. In some embodiments, the vector generation module 110 uses a transformer architecture to generate the feature vectors. Other types of machine learning algorithms and architectures are also within the scope of the present disclosure.

In one or more embodiments, the vector repository 170 stores feature vectors generated by the vector generation module 110. In one example, the vector repository 170 stores the feature vectors of the dataset schemas in a vector database that is configured to store high-dimensional representations of data features. Compared to standard scalar-based databases and independent vector indexes, vector databases are more efficient for storing and retrieving feature vectors at scale, offering the capacity to effectively store and retrieve massive quantities of data for vector search functions. Vector databases also use replication and sharding techniques to provide fault tolerance and uninterrupted performance. Other implementations of the vector repository 170 are also within the scope of the present disclosure.

In some embodiments, the prompt integration module 120 is configured to generate an instruction for the LLM 130 to generate a query. The prompt integration module 120 selects one or more dataset schemas and integrates the selected dataset schema(s) with the natural language prompt in the instruction for the LLM 130. In one example, the prompt integration module 120 selects one or more dataset schemas from the metadata repository 160 and generates the instruction to specify the natural language prompt and the selected dataset schema(s). The prompt integration module 120 may select dataset schemas for inclusion in the instruction for the LLM 130 based on a level of similarity between the dataset schemas and the natural language prompt. In one or more embodiments, the prompt integration module 120 compares the feature vector of the natural language prompt to the corresponding feature vector of each of a set of dataset schemas to identify a subset of dataset schemas that satisfy a first similarity criteria for integration with the natural language prompt in the instruction for the LLM 130.

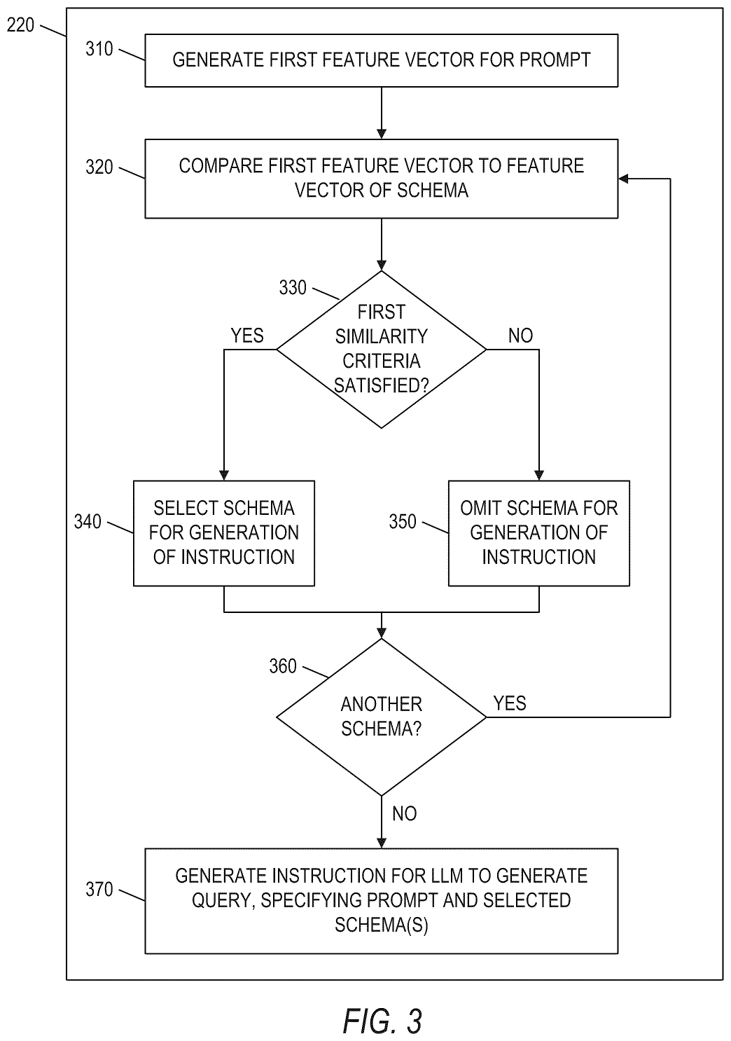

In some embodiments, even if a dataset schema does not satisfy the first similarity criteria based on the comparison of the feature vector of the natural language prompt to the feature vector of the dataset schema, the prompt integration module 120 still selects the dataset schema based on determining that the feature vector of the dataset schema is semantically related to another feature vector of another dataset schema that satisfied the first similarity criteria in relation to the feature vector of the natural language prompt. In one or more embodiments, if a dataset schema does not satisfy the first similarity criteria based on the comparison of the feature vector of the natural language prompt to the feature vector of the dataset schema, the prompt integration module 120 further requires that the feature vector of the dataset schema satisfies a second similarity criteria different from the first similarity criteria in comparison to the feature vector of the natural language prompt in addition to the semantic relationship determination in order to select the dataset schema for inclusion in the instruction for the LLM 130. The selection of the dataset schemas for inclusion in the instruction for the LLM 130 will be discussed in further detail below with respect to FIGS. 3, 4, and 5.

In one or more embodiments, the LLM 130 is configured to generate a query based on the instruction generated by the prompt integration module 120. The LLM 130 is a machine learning model that performs natural language processing tasks to process human language, such as the combination of the natural language prompt and the selected dataset schema(s) specified in the instruction. In one embodiment, the LLM 130 uses a deep neural network to generate outputs based on patterns learned from training data. The LLM 130 may include an implementation of a transformer-based architecture. In contrast to recurrent neural networks that use recurrence as the main mechanism for capturing relationships between tokens in a sequence, transformer-based neural networks use self-attention as their mechanism for capturing relationships. Other implementations of the LLM 130 are also within the scope of the present disclosure.

In some embodiments, the query execution module 140 is configured to receive the query generated by the LLM 130 and execute the query on the data repository 150 to generate a set of one or more results. In one or more embodiments, the query execution module 140 is further configured to store the set of one or more results generated based on the execution of the query on the data repository 150. In an embodiment, the query execution module 140 is also configured to present the set of one or more results in response to the natural language prompt. For example, the query execution module 140 may trigger the display of the set of one or more results on a computing device, such as on the computing device from which the natural language prompt of the user input was received. The query execution module 140 may present the set of one or more results in audio form or in some other format on the computing device.

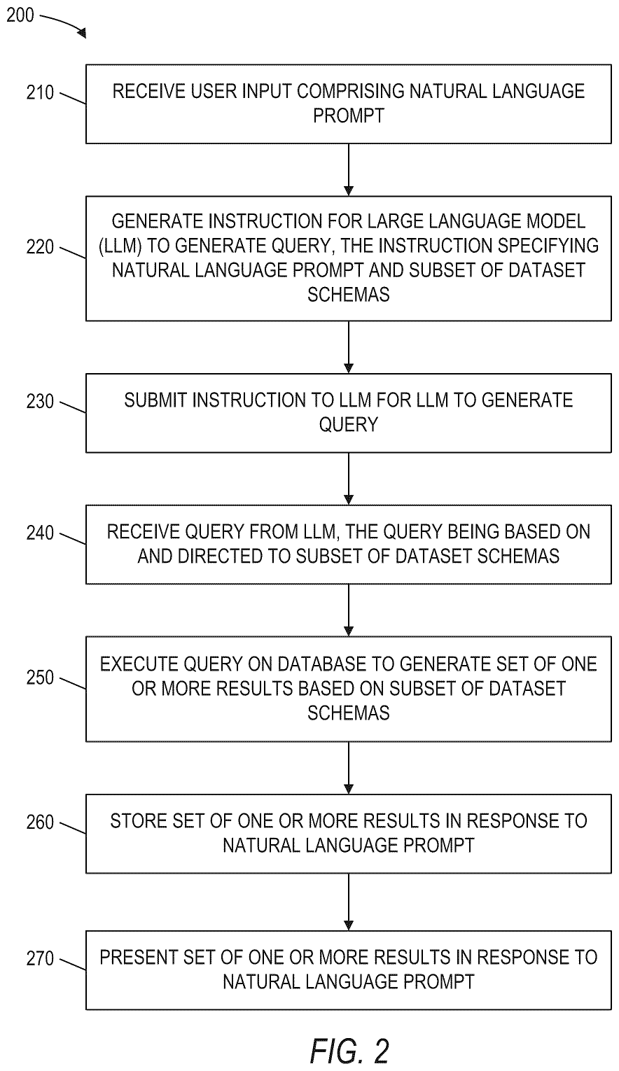

In one or more embodiments, the system 100 refers to hardware and/or software configured to perform operations described herein for integrating dataset schemas with natural language prompts to generate queries. Examples of operations for integrating dataset schemas with natural language prompts to generate queries, as well as further details of the features and functions of the system 100, are described below with reference to FIGS. 2, 3, 4, and 5.

Additional embodiments and/or examples relating to computer networks are described below in Section 5, titled “Computer Networks and Cloud Networks.”

### 3. INTEGRATING DATASET SCHEMAS WITH NATURAL LANGUAGE PROMPTS FOR ENHANCED QUERY GENERATION

FIG. 2 illustrates an example set of operations 200 for integrating dataset schemas with natural language prompts for enhanced query generation accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system 100 receiving user input comprising a natural language prompt (Operation 210). In some embodiments, the user input is received in the form of audio input spoken by a user into a microphone of a computing device. In other embodiments, the user input is received in the form of text that has been entered via a keyboard by a user of a computing device. The user input may be received in other forms and using other devices as well. In one or more embodiments, the natural language prompt includes a request for a task to be performed by a computer system. In one example, the natural language prompt includes a request for information based on data stored and managed by a CAASM system, such as a request for a list of devices associated with a particular user or a request for a list of vulnerabilities of a particular device. Other types of natural language prompts are also within the scope of the present disclosure.

In one or more embodiments, the system 100 generates an instruction for the LLM 130 to generate a query (Operation 220). In some embodiments, the instruction specifies the natural language prompt and one or more subsets of dataset schemas. In an embodiment, the system 100 selects the one or more subsets of dataset schemas from a plurality of dataset schemas stored in the metadata repository 160. Each dataset schema in the plurality of dataset schemas defines the data that is stored in a corresponding data structure in the data repository 150. In one example in which each dataset schema corresponds to a different table in the data repository 150, each dataset schema defines the data that is stored in the table that corresponds to the dataset schema. For example, the dataset schema may specify a name and data type for each field in the corresponding table. Other forms of the dataset schema are also within the scope of the present disclosure.

In an embodiment, the instruction further specifies one or more rules restricting database operations to be used in executing the query on the data repository 150. One example of a rule that may be included in the instruction comprises a rule that the database operations to be performed in the execution of the query be restricted to READ operations. Another example of a rule that may be included in the instruction comprises a rule that no DELETE operations may be performed in the execution of the query. Yet another example of a rule that may be included in the instruction comprises a rule that no operations that change or rename an object in a table may be performed in the execution of the query. Other restrictions are also within the scope of the present disclosure.

In some embodiments, the system 100 submits the instruction to the LLM 130 (Operation 230). In one example, the system 100 feeds the instruction as input into the LLM 130. In an embodiment in which the LLM 130 is external to the system 100, the system 100 transmits the instruction to the external system in which the LLM 130 is running as part of a request to generate the query. In response to the system 100 submitting the instruction to the LLM 130, the LLM 130 generates the query based on the instruction.

In one or more embodiments, the system 100 receives the query from the LLM 130 (Operation 240). The query is based on the natural language prompt. The query is also based on and directed to the selected subset(s) of dataset schemas. In an embodiment, the query is structured as a database query. For example, the query may be structured as one or more structured query language (SQL) statements specifying the data to return based on the natural language prompt and the target(s) from which to obtain the data based on the selected dataset schema(s). However, the query may be structured in other ways as well.

In an embodiment, the system 100 executes the query on the data repository 150 to generate a set of one or more results obtained using the selected subset(s) of dataset schemas (Operation 250). In one example, a database of the data repository 150 executes the query, selecting data from the table(s) corresponding to the selected subset(s) of dataset schemas based on a specification of desired data that was indicated in the natural language prompt. In an embodiment in which the data repository 150 is external to the system 100, the system 100 transmits the query to the data repository 150 as part of a request to execute the query.

In some embodiments, the system 100 stores the set of one or more results in response to the natural language prompt (Operation 260). In one example, in response to receiving the set of one or more results obtained based on the execution of the query on the data repository 150, the system 100 stores the set of one or more results in short-term memory, such as in random-access memory (RAM) of the system 100. In another example, in response to receiving the set of one or more results obtained based on the execution of the query on the data repository 150, the system 100 stores the set of one or more results in long-term memory, such as in a data repository (e.g., in the data repository 150).

In an embodiment, the system 100 presents the set of one or more results in response to the natural language prompt (Operation 270). In some embodiments, in response to receiving the user input including the natural language prompt from a computing device of a user and receiving the set of one or more results generated in response to the natural language prompt, the system 100 triggers the presentation of the set of one or more results on the computing device. In one example, the system 100 triggers the presentation of the set of one or more results by triggering a display of the set of one or more results on the computing device. In another example, the system 100 triggers the presentation of the set of one or more results by triggering a playing of audio describing the set of one or more results on the computing device. Other ways of presenting the set of one or more results are also within the scope of the present disclosure.

### 4. EXAMPLE EMBODIMENTS

Detailed examples are described below for purposes of clarity. Components and/or operations described below should be understood as one specific example that may not be applicable to certain embodiments. Accordingly, components and/or operations described below should not be construed as limiting the scope of any of the claims.

FIG. 3 illustrates an example set of operations for generating an instruction for an LLM to generate a query (Operation 220) in accordance with one or more embodiments. One or more operations illustrated in FIG. 3 may be modified, rearranged, or omitted. Accordingly, the particular sequence of operations illustrated in FIG. 3 should not be construed as limiting the scope of one or more embodiments.

In an embodiment, the system 100 executes an embedding operation to generate a first feature vector corresponding to the natural language prompt (Operation 310). In some embodiments, the first feature vector is a numerical representation of a set of features of the natural language prompt. In one or more embodiments, the system 100 generates the first feature vector using a machine learning algorithm. In one example, the system 100 uses a deep convolutional neural network to generate the first feature vector for the natural language prompt. The system 100 may use a transformer architecture to generate the first feature vector. However, other types of machine learning algorithms and architectures may also be used to generate the first feature vector for the natural language prompt.

In one or more embodiments, the system 100 compares the first feature vector for the natural language prompt to each feature vector in a set of feature vectors that correspond respectively to a set of dataset schemas of the data repository 150 (Operation 320). The system 100 may obtain the set of feature vectors corresponding to the set of dataset schemas from the metadata repository 160. In some embodiments, the system 100 calculates corresponding similarity metrics between the first feature vector of the natural language prompt and the respective feature vectors of the dataset schemas (e.g., a first similarity metric between the first feature vector of the natural language prompt and the corresponding feature vector of a first dataset schema, a second similarity metric between the first feature vector of the natural language prompt and the corresponding feature vector of a second dataset schema, etc.). In one or more embodiments, the similarity metrics comprise cosine similarities between the respective feature vectors. In other embodiments, the similarity metrics comprise cosine distances between the respective feature vectors. Other types of similarity metrics are also within the scope of the present disclosure.

In an embodiment, the system 100 determines, for a dataset schema in the set of dataset schemas, if the corresponding feature vector of the dataset schema satisfies a first similarity criteria in relation to the first feature vector of the natural language prompt (Operation 330). In some embodiments in which the system 100 calculated a similarity metric for the first feature vector of the natural language prompt and the corresponding feature vector of the dataset schema, the system 100 determines if the similarity metric satisfies a first threshold value. In one or more embodiments in which the similarity metric comprises a cosine similarity, the system 100 determines that the first similarity criteria is satisfied if the cosine similarity is equal to or above the first threshold value and determines that the first similarity criteria is not satisfied if the cosine similarity is below the first threshold value. In one or more embodiments in which the similarity metric comprises a cosine distance, the system 100 determines that the first similarity criteria is satisfied if the cosine distance is equal to or below the first threshold value and determines that the first similarity criteria is not satisfied if the cosine distance is above the first threshold value. Other techniques for determining if the first similarity criteria is satisfied are also within the scope of the present disclosure.

In one or more embodiments, if the system 100 determines that the corresponding feature vector of the dataset schema satisfies the first similarity criteria in relation to the first feature vector of the natural language prompt, then the system 100 selects the dataset schema for inclusion in the instruction to the LLM 130 to generate the query (Operation 340). In some embodiments, the system 100 adds the dataset schema to a list of dataset schemas to be included in the instruction to the LLM 130 to generate the query based on the selection. However, other techniques for tracking the dataset schemas that have been selected for inclusion in the instruction to the LLM 130 are also within the scope of the present disclosure.

In one or more embodiments, if the system 100 determines that the corresponding feature vector of the dataset schema does not satisfy the first similarity criteria in relation to the first feature vector of the natural language prompt, then the system 100 omits the dataset schema for inclusion in the instruction to the LLM 130 to generate the query (Operation 350). In some embodiments, the system 100 omits the dataset schema from a list of dataset schemas to be included in the instruction to the LLM 130 to generate the query based on determining that the feature vector of the dataset schema does not satisfy the first similarity criteria in relation to the first feature vector of the natural language prompt. In one or more embodiments, the system 100 further adds the dataset schema to a list of dataset schemas that have not satisfied the first similarity criteria in relation to the natural language prompt. However, other techniques for tracking the dataset schemas that have not satisfied the first similarity criteria are also within the scope of the present disclosure.

In an embodiment, the system 100 determines there are any other dataset schemas for which it should compare the corresponding feature vector of the dataset schema with the first feature vector to determine if the corresponding feature vector satisfies the first similarity criteria in relation to the first feature vector of the natural language prompt (Operation 360). In some embodiments, the system 100 determines that there is another dataset schema for which it should make the comparison by determining if there are any remaining dataset schemas in a set of dataset schemas for which this comparison has not yet been made. For example, if there is a remaining dataset schema in the set of dataset schemas for which this comparison has not yet been made, then the system 100 may determine that there is another dataset schema for which it should make this determination. If there are not any remaining dataset schemas in the set of dataset schemas for which this comparison has not yet been made, then the system 100 may determine that there are not any other dataset schemas for which it should make this determination. In some other embodiments, the system 100 determines that there is another dataset schema for which it should make the comparison by determining if the number of dataset schemas that have been selected for inclusion in the instruction to the LLM 130 meets a minimum threshold value. For example, if the number of dataset schemas selected for inclusion in the instruction to the LLM 130 is below the minimum threshold value, then the system 100 may determine that there is another dataset schema for which it should make this determination. If the number of dataset schemas selected for inclusion in the instruction to the LLM 130 is equal to or above the minimum threshold value, then the system 100 may determine that there are not any other dataset schemas for which it should make this determination.

In one or more embodiments, if the system 100 determines that there is another dataset schema for which it should compare the corresponding feature vector of that dataset schema with the first feature vector to determine if the corresponding feature vector satisfies the first similarity criteria in relation to the first feature vector of the natural language prompt, then the system 100 returns to comparing the corresponding feature vector of that dataset schema with the first feature vector (Operation 320). If the system 100 determines that there are not any other dataset schemas for which it should compare the corresponding feature vector of that dataset schema with the first feature vector of the natural language prompt, then then system 100 proceeds to generate the instruction to the LLM 130 for the LLM 130 to generate the query (Operation 370). In one or more embodiments, the instruction specifies the natural language prompt and the selected dataset schema(s). For example, the system 100 may access the list of selected dataset schemas and integrate the selected dataset schema(s) in the list with the natural language prompt in generating the instruction.

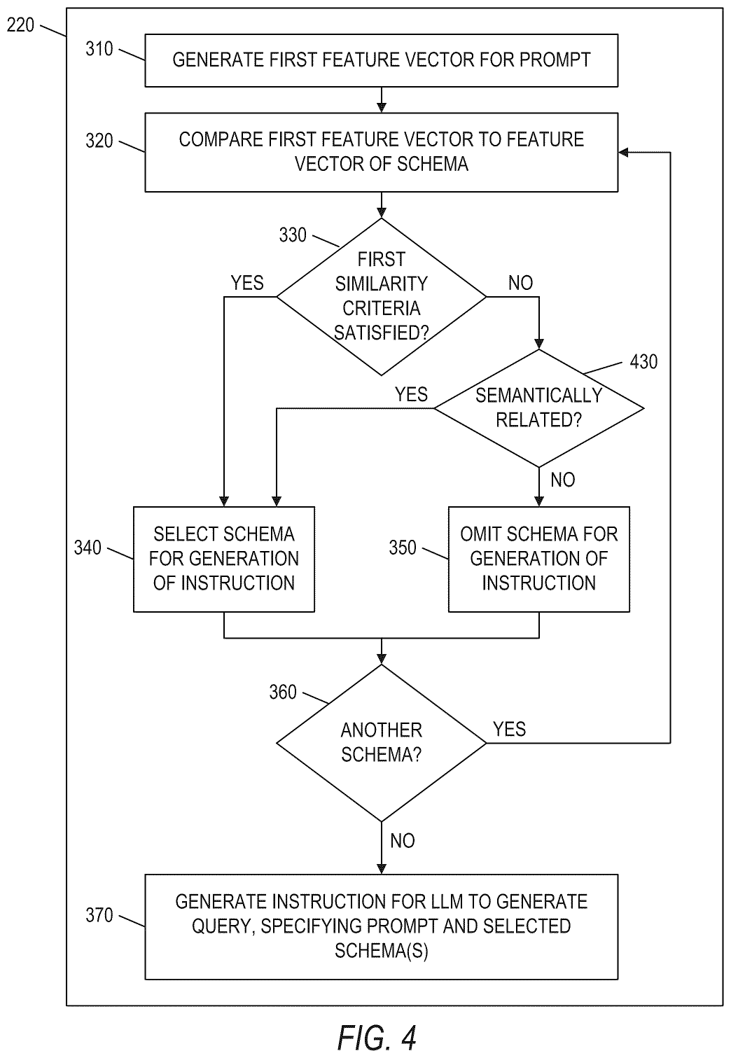

FIG. 4 illustrates another example set of operations for generating an instruction for an LLM to generate a query (Operation 220) in accordance with one or more embodiments. One or more operations illustrated in FIG. 4 may be modified, rearranged, or omitted. Accordingly, the particular sequence of operations illustrated in FIG. 4 should not be construed as limiting the scope of one or more embodiments.

In some embodiments, even if a dataset schema does not satisfy the first similarity criteria (Operation 330), the system 100 may still select that dataset schema based on determining that the dataset schema is semantically related to a dataset schema that did satisfy the first similarity criteria (Operation 430). In one or more embodiments, if the system 100 determines that the corresponding feature vector of the dataset schema does not satisfy the first similarity criteria in relation to the first feature vector of the natural language prompt, then the system 100 determines if the dataset schema is semantically related to any dataset schemas whose corresponding feature vector was determined to satisfy the first similarity criteria in relation to the first feature vector of the natural language prompt (Operation 430). In an embodiment, the system 100 uses semantic analysis to determine if there is a semantic relationship between the dataset schemas. In one or more embodiments, the system 100 uses a natural language processing algorithm to compare dataset schemas and determine if they are semantically related. In one example, the system 100 includes the dataset schemas aa part of a request to the LLM 130 to determine if the dataset schemas are semantically related.

In one or more embodiments, if the system 100 determines that the dataset schema that does not satisfy the first similarity criteria is semantically related to another dataset schema that does satisfy the first similarity criteria, then the system 100 selects the dataset schema that does not satisfy the first similarity criteria for inclusion in the instruction to the LLM 130 to generate the query (Operation 340). In one or more embodiments, if the system 100 determines that the dataset schema that does not satisfy the first similarity criteria is not semantically related to any other dataset schema that does satisfy the first similarity criteria, then the system 100 omits the dataset schema that does not satisfy the first similarity criteria for inclusion in the instruction to the LLM 130 to generate the query (Operation 350).

In some embodiments, the system 100 first evaluates all of the dataset schemas in the set of dataset schemas to identify the dataset schemas that satisfy the first similarity criteria in relation to the natural language prompt and to identify the dataset schemas that do not satisfy the first similarity criteria in relation to the natural language prompt. Then, for each dataset schema that is identified as not satisfying the first similarity criteria, the system 100 compares the dataset schema that is identified as not satisfying the first similarity criteria to the dataset schemas that are identified as satisfying the first similarity criteria to determine if the dataset schema that is identified as not satisfying the first similarity criteria is semantically related to any of the dataset schemas that are identified as satisfying the first similarity criteria. The system 100 may compare the dataset schema identified as not satisfying the first similarity criteria with the dataset schemas that are identified as satisfying the first similarity criteria one-by-one in a linear serial order until a semantic relation is determined.

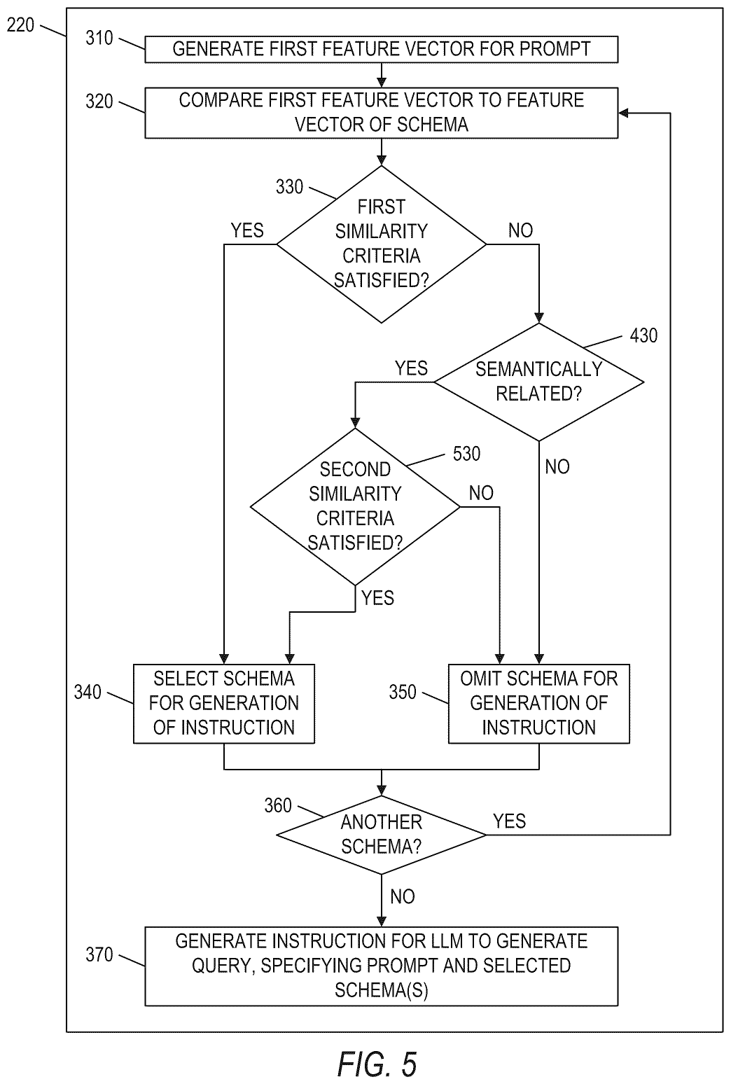

FIG. 5 illustrates yet another example set of operations for generating an instruction for an LLM to generate a query (Operation 220) in accordance with one or more embodiments. One or more operations illustrated in FIG. 5 may be modified, rearranged, or omitted. Accordingly, the particular sequence of operations illustrated in FIG. 5 should not be construed as limiting the scope of one or more embodiments.

In some embodiments, in addition to requiring that the dataset schema is semantically related to a dataset schema that satisfied the first similarity criteria (Operation 430) to include the dataset schema in the instruction to the LLM when the dataset schema does not satisfy the first similarity criteria (Operation 330), the system 100 further requires that the dataset schema satisfy a second similarity criteria that is different from the first similarity criteria (Operation 530). In one or more embodiments, after determining that a dataset schema that does not satisfy the first similarity criteria in relation to the natural language prompt is semantically related to a dataset schema that does satisfy the first similarity criteria, the system 100 determines if a corresponding feature vector of the dataset schema (that does not satisfy the first similarity criteria) satisfies a second similarity criteria in relation to the first feature vector. The second similarity criteria is different from the first similarity criteria. For example, in an embodiment in which the first similarity criteria comprises a condition that a cosine similarity between the corresponding feature vector of the dataset schema and the first feature vector of the natural language prompt is equal to or above the first threshold value, the second similarity criteria comprises a condition that the cosine similarity between the corresponding feature vector of the dataset schema and the first feature vector of the natural language prompt is equal to or above a second threshold value that is less than the first threshold value. In another embodiment in which the first similarity criteria comprises a condition that a cosine distance between the corresponding feature vector of the dataset schema and the first feature vector of the natural language prompt is equal to or below the first threshold value, the second similarity criteria comprises a condition that the cosine distance between the corresponding feature vector of the dataset schema and the first feature vector of the natural language prompt is equal to or below a second threshold value that is greater than the first threshold value.

In one or more embodiments, if the system 100 determines that the dataset schema does satisfy the second similarity criteria, then the system 100 selects the dataset schema that for inclusion in the instruction to the LLM 130 to generate the query (Operation 340). In one or more embodiments, if the system 100 determines that the dataset schema does not satisfy the second similarity criteria, then the system 100 omits the dataset schema that does not satisfy the second similarity criteria for inclusion in the instruction to the LLM 130 to generate the query (Operation 350).

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. One or more non-transitory computer-readable media storing instructions which, when executed by one or more hardware processors, cause performance of operations comprising:
receiving user input comprising a natural language prompt;
generating an instruction for a Large Language Model (LLM) to generate a query at least by:
executing an embedding operation to generate a first feature vector corresponding to the natural language prompt;
comparing the first feature vector to each of a set of feature vectors corresponding respectively to a set of dataset schemas of a data repository to determine that a first subset of feature vectors, of the set of feature vectors, meets a first similarity criteria in relation to the first feature vector;
responsive to determining that the first subset of feature vectors meet the first similarity criteria in relation to the first feature vector: selecting a first subset of dataset schemas that correspond to the first subset of feature vectors for generation of the instruction; and
generating the instruction to the LLM for the LLM to generate the query, the instruction specifying the natural language prompt and the first subset of dataset schemas;
submitting the instruction to the LLM, wherein the LLM generates the query based on the instruction;
receiving the query from the LLM, wherein the query is based on and directed to the first subset of dataset schemas;
executing the query on the data repository to generate a set of one or more results based on the first subset of dataset schemas; and
storing the set of one or more results in response to the natural language prompt.

2. The media of claim 1, wherein the operations further comprise:
presenting the set of one or more results in response to the natural language prompt.

3. The media of claim 1, wherein the operations further comprise:
determining that a second subset of dataset schemas are semantically related to at least one of the first subset of dataset schemas; and
responsive to determining that the second subset of dataset schemas are semantically related to at least one of the first subset of dataset schemas, selecting the second subset of dataset schemas for use in generating the instruction;
wherein the instruction further specifies the second subset of dataset schemas; and
wherein the set of one or more results is based further on the second set of dataset schemas.

4. The media of claim 1, wherein the operations further comprise:
determining that a second subset of dataset schemas are semantically related to at least one of the first subset of dataset schemas;
determining a second subset of feature vectors, of the set of feature vectors, that correspond to the second subset of dataset schemas;
comparing the first feature vector to each of the second subset of feature vectors to determine that the second subset of feature vectors meet a second similarity criteria in relation to the first feature vector, wherein the second similarity criteria is different from the first similarity criteria; and
responsive to (a) determining that the second subset of dataset schemas are semantically related to at least one of the first subset of dataset schemas and (b) determining that the second subset of feature vectors meet the second similarity criteria in relation to the first feature vector:
selecting the second subset of dataset schemas for use in generating the instruction;
wherein the instruction further specifies the second subset of dataset schemas; and
wherein the set of one or more results is based further on the second set of dataset schemas.

5. The media of claim 4, wherein:
the comparing the first feature vector to each of the set of feature vectors to determine that the first subset of feature vectors meets the first similarity criteria in relation to the first feature vector comprises:
calculating a first set of corresponding similarity metrics between the first feature vector and each of the set of feature vectors; and
determining that the first set of corresponding similarity metrics between the first feature vector and each of the first subset of feature vectors meet a first threshold value; and
the comparing the first feature vector to each of the second subset of feature vectors comprises:
calculating a second set of corresponding similarity metrics between the first feature vector and each of the second subset of feature vectors; and
determining that the second set of corresponding similarity metrics between the first feature vector and each of the second subset of feature vectors meet a second threshold value, wherein the second threshold value is different from the first threshold value.

6. The media of claim 5, wherein:
the calculating the first set of corresponding similarity metrics between the first feature vector and each of the set of feature vectors comprises calculating a first set of corresponding cosine similarities between the first feature vector and each of the set of feature vectors;
the determining that the first set of corresponding similarity metrics between the first feature vector and each of the first subset of feature vectors meet the first threshold value comprises determining that the first set of corresponding cosine similarities is equal to or above the first threshold value;
the calculating the second set of corresponding similarity metrics between the first feature vector and each of the second subset of feature vectors comprises calculating a second set of corresponding cosine similarities between the first feature vector and each of the second subset of feature vectors; and
the determining that the second set of corresponding similarity metrics between the first feature vector and each of the second subset of feature vectors meet the second threshold value comprises determining that the second set of corresponding cosine similarities is equal to or above the second threshold value, wherein the second threshold value less than the first threshold value.

7. The media of claim 5, wherein:
the calculating the first set of corresponding similarity metrics between the first feature vector and each of the set of feature vectors comprises calculating a first set of corresponding cosine distances between the first feature vector and each of the set of feature vectors;
the determining that the first set of corresponding similarity metrics between the first feature vector and each of the first subset of feature vectors meet the first threshold value comprises determining that the first set of corresponding similarity distances is equal to or below the first threshold value;
the calculating the second set of corresponding similarity metrics between the first feature vector and each of the second subset of feature vectors comprises calculating a second set of corresponding cosine distances between the first feature vector and each of the second subset of feature vectors; and
the determining that the second set of corresponding similarity metrics between the first feature vector and each of the second subset of feature vectors meet the second threshold value comprises determining that the second set of corresponding similarity distances is equal to or below the second threshold value, wherein the second threshold value greater than the first threshold value.

8. The media of claim 1, wherein each dataset schema in the set of dataset schemas corresponds to a different table in the data repository, and each dataset schema defines data that is stored in the table corresponding to the dataset schema.

9. The media of claim 1, wherein the instruction further specifies one or more rules restricting database operations to be used in executing the query on the data repository.

10. A method performed by at least one device including a hardware processor, the method comprising:
receiving user input comprising a natural language prompt;
generating an instruction for a Large Language Model (LLM) to generate a query at least by:
executing an embedding operation to generate a first feature vector corresponding to the natural language prompt;
comparing the first feature vector to each of a set of feature vectors corresponding respectively to a set of dataset schemas of a data repository to determine that a first subset of feature vectors, of the set of feature vectors, meets a first similarity criteria in relation to the first feature vector;
responsive to determining that the first subset of feature vectors meet the first similarity criteria in relation to the first feature vector: selecting a first subset of dataset schemas that correspond to the first subset of feature vectors for generation of the instruction; and
generating the instruction to the LLM for the LLM to generate the query, the instruction specifying the natural language prompt and the first subset of dataset schemas;
submitting the instruction to the LLM, wherein the LLM generates the query based on the instruction;
receiving the query from the LLM, wherein the query is based on and directed to the first subset of dataset schemas;
executing the query on the data repository to generate a set of one or more results based on the first subset of dataset schemas; and
storing the set of one or more results in response to the natural language prompt.

11. The method of claim 10, further comprising:
presenting the set of one or more results in response to the natural language prompt.

12. The method of claim 10, further comprising:
determining that a second subset of dataset schemas are semantically related to at least one of the first subset of dataset schemas; and
responsive to determining that the second subset of dataset schemas are semantically related to at least one of the first subset of dataset schemas, selecting the second subset of dataset schemas for use in generating the instruction;
wherein the instruction further specifies the second subset of dataset schemas; and
wherein the set of one or more results is based further on the second set of dataset schemas.

13. The method of claim 10, wherein the operations further comprise:
determining that a second subset of dataset schemas are semantically related to at least one of the first subset of dataset schemas;
determining a second subset of feature vectors, of the set of feature vectors, that correspond to the second subset of dataset schemas;
comparing the first feature vector to each of the second subset of feature vectors to determine that the second subset of feature vectors meet a second similarity criteria in relation to the first feature vector, wherein the second similarity criteria is different from the first similarity criteria; and
responsive to (a) determining that the second subset of dataset schemas are semantically related to at least one of the first subset of dataset schemas and (b) determining that the second subset of feature vectors meet the second similarity criteria in relation to the first feature vector:
selecting the second subset of dataset schemas for use in generating the instruction;
wherein the instruction further specifies the second subset of dataset schemas; and
wherein the set of one or more results is based further on the second set of dataset schemas.

14. The method of claim 13, wherein:
the comparing the first feature vector to each of the set of feature vectors to determine that the first subset of feature vectors meets the first similarity criteria in relation to the first feature vector comprises:
calculating a first set of corresponding similarity metrics between the first feature vector and each of the set of feature vectors; and
determining that the first set of corresponding similarity metrics between the first feature vector and each of the first subset of feature vectors meet a first threshold value; and
the comparing the first feature vector to each of the second subset of feature vectors comprises:
calculating a second set of corresponding similarity metrics between the first feature vector and each of the second subset of feature vectors; and
determining that the second set of corresponding similarity metrics between the first feature vector and each of the second subset of feature vectors meet a second threshold value, wherein the second threshold value is different from the first threshold value.

15. The media of claim 14, wherein:
the calculating the first set of corresponding similarity metrics between the first feature vector and each of the set of feature vectors comprises calculating a first set of corresponding cosine similarities between the first feature vector and each of the set of feature vectors;
the determining that the first set of corresponding similarity metrics between the first feature vector and each of the first subset of feature vectors meet the first threshold value comprises determining that the first set of corresponding cosine similarities is equal to or above the first threshold value;
the calculating the second set of corresponding similarity metrics between the first feature vector and each of the second subset of feature vectors comprises calculating a second set of corresponding cosine similarities between the first feature vector and each of the second subset of feature vectors; and
the determining that the second set of corresponding similarity metrics between the first feature vector and each of the second subset of feature vectors meet the second threshold value comprises determining that the second set of corresponding cosine similarities is equal to or above the second threshold value, wherein the second threshold value less than the first threshold value.

16. The media of claim 14, wherein:
the calculating the first set of corresponding similarity metrics between the first feature vector and each of the set of feature vectors comprises calculating a first set of corresponding cosine distances between the first feature vector and each of the set of feature vectors;
the determining that the first set of corresponding similarity metrics between the first feature vector and each of the first subset of feature vectors meet the first threshold value comprises determining that the first set of corresponding similarity distances is equal to or below the first threshold value;
the calculating the second set of corresponding similarity metrics between the first feature vector and each of the second subset of feature vectors comprises calculating a second set of corresponding cosine distances between the first feature vector and each of the second subset of feature vectors; and
the determining that the second set of corresponding similarity metrics between the first feature vector and each of the second subset of feature vectors meet the second threshold value comprises determining that the second set of corresponding similarity distances is equal to or below the second threshold value, wherein the second threshold value greater than the first threshold value.

17. The method of claim 10, wherein each dataset schema in the set of dataset schemas corresponds to a different table in the data repository, and each dataset schema defines data that is stored in the table corresponding to the dataset schema.

18. The method of claim 10, wherein the instruction further specifies one or more rules restricting database operations to be used in executing the query on the data repository.

19. A system comprising:
at least one device including a hardware processor;
the system being configured to perform operations comprising:
receiving user input comprising a natural language prompt;
generating an instruction for a Large Language Model (LLM) to generate a query at least by:
executing an embedding operation to generate a first feature vector corresponding to the natural language prompt;
comparing the first feature vector to each of a set of feature vectors corresponding respectively to a set of dataset schemas of a data repository to determine that a first subset of feature vectors, of the set of feature vectors, meets a first similarity criteria in relation to the first feature vector;
responsive to determining that the first subset of feature vectors meet the first similarity criteria in relation to the first feature vector: selecting a first subset of dataset schemas that correspond to the first subset of feature vectors for generation of the instruction; and
generating the instruction to the LLM for the LLM to generate the query, the instruction specifying the natural language prompt and the first subset of dataset schemas;
submitting the instruction to the LLM, wherein the LLM generates the query based on the instruction;
receiving the query from the LLM, wherein the query is based on and directed to the first subset of dataset schemas;
executing the query on the data repository to generate a set of one or more results based on the first subset of dataset schemas; and
storing the set of one or more results in response to the natural language prompt.

20. The system of claim 19, wherein the operations further comprise:
presenting the set of one or more results in response to the natural language prompt.
